(19) United States
(12) Patent Application Publication
(10) Pub. No.: US 2021/0103950 A1
(43) Pub. Date: Apr. 8, 2021

(54) PERSONALISED DISCOUNT GENERATION SYSTEM AND METHOD

(71) Applicant: Myntra Designs Private Limited, Muneshwara Nagar (IN)

(72) Inventor: Sajan Kedia, Bangalore (IN)

(21) Appl. No.: 16/731,393

(22) Filed: Dec. 31, 2019

(30) Foreign Application Priority Data
Oct. 5, 2019 (IN) 201941040461

(51) Int. Cl. G06Q 30/02; G06Q 30/06

(52) U.S. Cl. CPC G06Q 30/0239; G06Q 30/0631; G06Q 30/0253; G06Q 30/0633; G06Q 30/0603; G06Q 30/0641

(57) ABSTRACT

An e-commerce system for displaying and selling multiple products to a plurality of users is provided. The e-commerce system comprises a catalogue module configured to dynamically assemble a catalogue, wherein the catalogue comprises a plurality of products to be displayed on an e-commerce platform; wherein each product is attributed with a unique identifier and a corresponding personalised price for a specific user. The system further comprises a feature generation module configured to generate, for a specific product, an implicit score based on clickstream data; wherein the clickstream data comprises user clickstream data for a plurality of users and product clickstream data for the specific product. Further, the system comprises a vector module configured to generate an n-dimensional vector for each product based on its corresponding implicit score and a discount generation module configured to generate a personalised discount for each user; wherein the discount is computed based on the n-dimensional vector of the product.

### PRIORITY STATEMENT

The present application hereby claims priority to Indian patent application number 201941040461 filed on 5 Oct. 2019, the entire contents of which are hereby incorporated herein by reference.

### BACKGROUND

The present invention generally relates to retail shopping and more particularly to a system and method for generating a peronalised discount for each user on an e-commerce system.

In most online retail shopping platforms available today, discounts have become an integral part of the marketing strategies used to boost sales and revenue. E-commerce platforms rely upon discounts for a variety of reasons, such as to promote new and existing goods and services and to increase the sales of a particular item or service, or to increase the sales of the merchant's other goods and services. Further, consumers rely upon discounts as a way to reduce their costs.

In current systems, discounts and promotions are periodically applied to attract more customers. Discounts are usually provided to the customer by way of discount coupons or is directly applied to the product on display. However, these discounts are usually uniform across customers and usually does not take into account customer specific data. In some cases, the discount coupons or rebates (or the advertisements containing the coupons or rebates) end up outside of the target customers. This in turn, leads to the discounts being under utilized which means that its impact on sales and/or revenue is very small.

Therefore, there is a need for building a system to generate personalised discounts for each customer, thereby ensuring a higher probability of conversion to a sale which in turn will increase the revenues and margin of the e-commerce retailer.

### SUMMARY

The following summary is illustrative only and is not intended to be in any way limiting. In addition to the illustrative aspects, example embodiments, and features described, further aspects, will become apparent by reference to the drawings and the following detailed description. Example embodiments provide a personalised discount generation system and method.

Briefly, according to one aspect of the present technique, an e-commerce system for displaying and selling multiple products to a plurality of users is provided. The e-commerce system comprises a catalogue module configured to dynamically assemble a catalogue, wherein the catalogue comprises a plurality of products to be displayed on an e-commerce platform; wherein each product is is attributed with a unique identifier and a corresponding personalised price for a specific user. The system further comprises a feature generation module configured to generate, for a specific product, an implicit score based on clickstream data; wherein the clickstream data comprises user clickstream data for a plurality of users and product clickstream data for the specific product. Further, the system comprises a vector module configured to generate an n-dimensional vector for each product based on its corresponding implicit score and a discount generation module configured to generate a personalised discount for each user; wherein the discount is computed based on the n-dimensional vector of the product.

In another embodiment, a method for generating a personalized discount for a desired product for a user. The method comprises presenting a plurality of products to the user; wherein each product is attributed with a unique identifier and a corresponding price, and generating, for each product, an implicit score based on the unique identifier and a trade discount. The method further comprises generating an n-dimensional vector for each product based on its corresponding implicit score and generating a personalised discount for the product available to the user. The personalized discount is computed based on the n-dimensional vector of the product.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an example fashion e-commerce system implemented according to aspects of the present technique;

FIG. 2 is a flow chart illustrating one method by which a personalised discount is calculated for a specific product and a corresponding user, implemented according to aspects of the present technique;

FIG. 3 is a pictorial representation of a e-commerce fashion platform as seen by different users, implemented to aspects of the present technique; and

FIG. 4 is a pictorial representation of a shopping bag for different users, implemented according to aspects of the present technique.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof

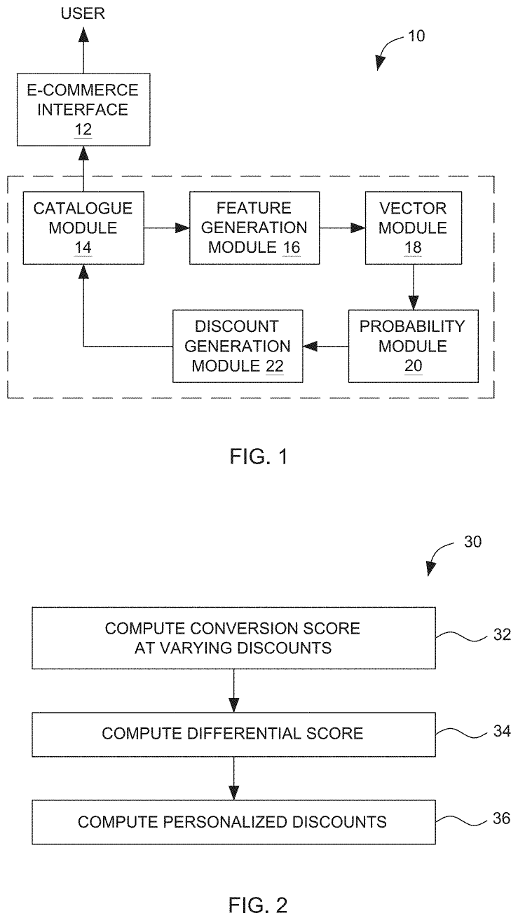

FIG. 1 is a block diagram of an example fashion e-commerce system implemented according to aspects of the present technique. It may be noted that although the figures and description is described with reference to a fashion e-commerce system, the techniques described herein can be implemented on other e-commerce platforms as well. The e-commerce system employs a user interface 12 that enables one or more users to browse multiple products available on the e-commerce platform 10. Each block is described in further detail below.

Catalogue module 14 is configured to dynamically assemble a catalogue which comprises a listing of all products available on the e-commerce platform. The products are displayed to the user logged on via the e-commerce platform via e-commerce interface 12. In one embodiment, each product on the catalogue is attributed with a unique identifier such as a product ID. Each product is also identified by its corresponding personalised price for the user viewing the product.

Feature generation module 16 is configured to generate an implicit score for each product in the catalogue. More specifically, the feature generation module 16 is configured to generated the implicit score based on clickstream data. In one embodiment, the clickstream data comprises user clickstream data for a plurality of users and product clickstream data for the specific product.

Vector module 18 is configured to generate an n-dimensional vector for each product based on its corresponding implicit score. In one embodiment, the n-dimensional vector is computed based on a specific user-product interaction matrix for each user and the corresponding product.

Probability module 20 is configured to compute, for each user-product combination, a conversion score at varying discounts. The probability module is further configured to calculate a differential score. In one embodiment, the differential score is based on the conversion scores at different discounts for the same product.

Discount generation module 22 is configured to generate a personalised discount for each user based on the conversion score and the differential score for the user-product combination. It may be noted that the discount coupon represents a discount amount or a discount percentage that will be deducted from the product's selling price. Further the discount is offered to a specific user for a specific product. As described above, the personalised discount is computed using a differential score. The manner in which this is computed is describe in further detail below.

FIG. 2 is a flow chart illustrating the manner in which a personalised discount is calculated for a specific product and a corresponding user, implemented according to aspects of the present technique. As described above, an n-dimensional vector is computed based on a specific user-product interaction matrix for each user and the corresponding product.

In step 32, a conversion score, at varying discounts, is computed for each user-product combination. The conversion score represents the probability of the user buying the product at a given discount. The conversion scores varies as the discount percentages changes as shown in Table 1.

TABLE 1

| Product | Discount | Conversion |
|---|---|---|
| (Jeans) | (%) | score |
| Brand A | 40 | 0.5694294 |
| Brand B | 50 | 0.64847958 |
| Brand C | 30 | 0.42109233 |
| Brand D | 40 | 0.4513427 |
| Brand E | 30 | 0.37298444 |
| Brand E | 70 | 0.35909706 |

In step 34, a differential score is computed. For example, for each product-user combination, the conversion score is generated at a base discount value. The difference of conversion score at different discount percentage for the same product is differential score. If this differential score is less then a threshold value, then the discount on that product for that user is decreased. Similarly, if the differential score is more then the threshold value, then the discount is increased. Therefore, a lower differential score indicates that the probability of buying a product (conversion score) is almost similar at the two different discounts. For example, in table 1, the differential score for Brand E at 30% discount and 70% discount is 0.02, which indicates that conversion score at either discount is almost similar. Hence, the product is displayed with 30% discount to the under.

In step 36, a personalised discount for a specific user-product combination is computed based on the differential score computed above. It may be noted that the personalized discount increases or decreases as a function of an increase or decrease in the differential score. Thus, different users using the e-commerce platform will have varying discounts for the same products. The manner in which this appears to the users is described in further detail below.

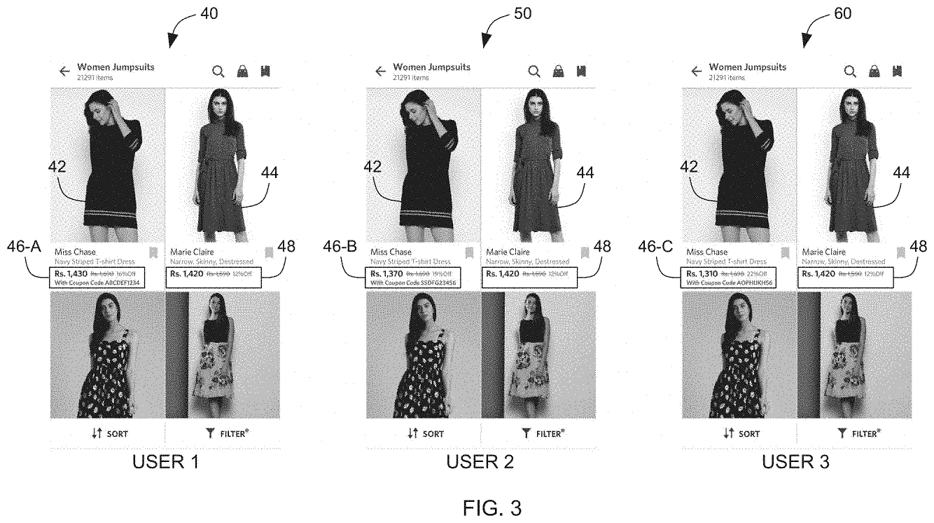

FIG. 3 is a pictorial representation of a e-commerce fashion platform as seen by different users, implemented to aspects of the present technique. It may be noted that the user interfaces shown in FIG. 3 is representative of its appearance on a handheld device. However, it may be understood that the e-commerce platform may be accessed using web applications on a computer as well.

Screen 40, 50 and 60 represents items appearing for three users—user 1, user 2 and user 3 respectively. Four clothing items are seen in each screen 40. 50 and 60. It may be noted that the price for item 42 is different for each user whereas the price (represented by general numeral 48) is the same for item 48.

Specifically, price 46-A for product 42 and user 1 combination is Rs.1430. Similarly price 46-B for product 42 and user 2 combination is Rs. 1370 and price 46-C for product 42 and user 3 combination is Rs. 1310. This is because the personalised discounts offered to all three users for the same product is different because each user's individual conversion score is different.

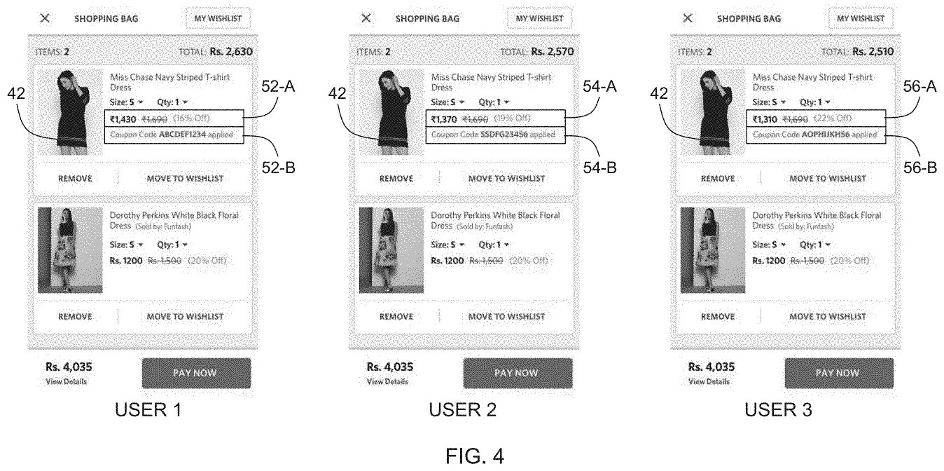

FIG. 4 is a pictorial representation of a shopping bag for different users, implemented according to aspects of the present technique. It may be seen that in the shopping bag of user 1, product 42 is priced at Rs. 1430 after applying a discount of 16% as shown by general reference numeral 52-A. General reference numeral 52-B is a unique coupon code generated for the product that represents a 16% peronalised discount.

Similarly, it may be seen that in the shopping bag of user 2, product 42 is priced at Rs. 1370 after applying a discount of 19% as shown by general reference numeral 54-A. General reference numeral 52-B is a unique coupon code generated for the product that represents a 19% peronalised discount.

Similarly, it may be seen that in the shopping bag of user 3, product 42 is priced at Rs. 1310 after applying a discount of 22% as shown by general reference numeral 54-A. General reference numeral 54-B is a unique coupon code generated for the product that represents a 22% peronalised discount.

From the above description, it may be understood that the present technique provides a personalised discount for the same product for different users. Since the personalised discount is computed based on a conversion score, the chance of the user buying the product because of the personalised price being offered is substantially increased. The personalised price has a direct impact on revenue as described in further detail below. Also, by analysing the lifetime browsing data of the user, it has been observed that a set of users display very high discount seeking behaviour, while another set of users seek ‘value’ products at an average price. Many such sets of users are identified and based on these sets of users, different personalized discounts are offered. This improves the overall conversion for all the segment of users and thus increases revenue and profit for the platform.

The system(s), described herein, may be realized by hardware elements, software elements and/or combinations thereof. For example, the modules and components illustrated in the example embodiments may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Embodiments of the present description provide for systems and methods for enhanced augmented reality experience by substantially reducing or eliminating any jitter that may be experienced by the user. In example embodiments, wherein the augmented reality experience is rendered on a hand-held device such as a mobile phone, Embodiments of the present description provide for systems and methods for augmented reality applications that may be implemented on mobile phones independent of the operating systems and/or the architecture of the mobile phone.

While only certain features of several embodiments have been illustrated, and described herein, many modifications and changes will occur to those skilled in the art. It is, therefore, to be understood that the appended claims are intended to cover all such modifications and changes as fall within the scope of the invention and the appended claims.

1. An e-commerce system for displaying and selling multiple products to a plurality of users, the e-commerce system comprising:
a catalogue module configured to dynamically assemble a catalogue, wherein the catalogue comprises a plurality of products to be displayed on an e-commerce platform; wherein each product is attributed with a unique identifier and a corresponding personalised price for a specific user;
a feature generation module configured to generate, for a specific product, an implicit score based on clickstream data; wherein the clickstream data comprises user clickstream data for a plurality of users and product clickstream data for the specific product;
a vector module configured to generate an n-dimensional vector for each product based on its corresponding implicit score; and
a discount generation module configured to generate a personalised discount for each user; wherein the discount is computed based on the n-dimensional vector of the product.

2. The e-commerce system of claim 1, wherein the n-dimensional vector is computed based a user-product interaction matrix for each user and product.

3. The e-commerce system of claim 1, wherein the implicit score is generated by applying a classification model on each user's profile date.

4. The e-commerce system of claim 1, further comprising a probability module configured to compute, for each user-product combination, a conversion score at varying discounts; and wherein the personalized discount is generated based on the conversion score.

5. The e-commerce system of claim 4, wherein the probability module is further configured to calculate the differential score based on the user's probability of conversion at a different discount for the same product.

6. The e-commerce system of claim 5, wherein the personalized discount is calculated based on the differential score.

7. The e-commerce system of claim 6, wherein the personalized discount increases or decreases as a function of an increase or decrease in the differential score.

8. The e-commerce system of claim 1, wherein the user clickstream data comprises browsing history, buying history, and the like.

9. The e-commerce system of claim 1, wherein the product clickstream data comprises data related to the product sales and product style.

10. A method for generating a personalized discount for a desired product for a user; the method comprising;
presenting a plurality of products to the user; wherein each product is attributed with a unique identifier and a corresponding price;
generating, for each product, an implicit score based on the unique identifier and a trade discount;
generating an n-dimensional vector for each product based on its corresponding implicit score; and
generating a personalised discount for the product available to the user; wherein the personalized discount is computed based on the n-dimensional vector of the product.

11. The method of claim 10, wherein the n-dimensional vector is computed based on the user's profile data received from a user profile database.

12. The method of claim 10, further comprising computing, for each product, a conversion score at varying discounts; and wherein the personalized discount is generated based on the conversion score.

13. The method of claim 12, further comprising computing a differential score for varying pairs of conversion scores; and wherein the personalized discount is calculated based on the differential score.

14. The method of claim 10, wherein the unique identifier for each product is identified based on its brand, an article and a gender.

15. The method of claim 10, wherein the n-dimensional vector is generated by implementing neural networks.
